(19) United States
(12) Patent Application Publication
(10) Pub. No.: US 2005/0271442 A1
(43) Pub. Date: Dec. 8, 2005

(54) High voltage resisting keyboard

(75) Inventors: David Ho, Taipei Hsien (TW); Tony Tsai, Taipei Hsien (TW); Tao Xia, Shanghai City (CN); Zhi-Zhong Hong, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/857,967

(22) Filed: Jun. 2, 2004

(51) Int. Cl. B41J 5/08

(52) U.S. Cl. 400/472

(57) ABSTRACT

The present invention discloses a high voltage resisting keyboard comprising at least one press key on a casing, a circuit board inside the casing, and a metal dome between the press keys and the circuit board inside the casing, wherein the edge of the metal hemisphere of the metal dome is directly connected to an end of an electrode of the circuit board, and the other end of the electrode is connected to an end of a resistor. Thus, when the edge of the metal hemisphere receives the high voltage current, the keyboard is protected by the resistor to avoid the high voltage current from being sent directly to another end of the resistor that is connected to another electronic component to achieve the purpose of protecting another electronic component.

### FIELD OF THE INVENTION

The present invention relates to keyboards, more particularly to a high voltage resisting keyboard comprising at least one press key on a casing, a circuit board inside the casing, a metal dome between the press keys and the circuit board inside the casing, wherein the edge of the metal hemisphere of the metal dome is connected directly to an end of an electrode of the circuit board, and the other end of the electrode is connected to an end of a resistor. Therefore, when the edge of the metal hemisphere receives a high voltage current, the keyboard is protected by the resistor to avoid the high voltage current from being sent directly to another end of the resistor which is connected to another electronic component to achieve the purpose of protecting another electronic component.

### BACKGROUND OF THE INVENTION

As science and technology develop vigorously in recent years, particularly the electronic technology is widely used in many areas. The electromagnetic environment becomes more complicated day after day, and more weight is taken in account for the issues related to the electromagnetic field effect of the electrostatic discharge (ESD) such as the electromagnetic interference (EMI) and the electromagnetic compatibility (EMC).

The electrostatic discharge problem exists almost anytime anywhere, but the problem was not as serious in the years from 1940˜1950, since the problems generated by the triodes and diodes at that time were not as common as that of the present electronic components. In the decade of 1960, the electrostatic discharge problem became more significant as the metal oxide semiconductor which is very sensitive to electrostatic charges was invented. Till the decade of 1970, as electronic components were miniaturized progressively, the electromagnetic discharge problem became more serious. In the decade 1980˜1990, as the density of integrated circuits became higher and higher since the silicon dioxide became thinner and thinner (micron˜nanometer), and the resistance to the electrostatic charge voltage became lower and lower. In addition, materials producing a large quantity of electromagnetic charges such as plastics and rubbers were used extensively, so that the existed electromagnetic charge is very common, and just the American electronic industry had lost about tens of billion dollars a year on electromagnetic discharges. Therefore, the electromagnetic discharge problem has become an invisible killer to the electronic industry, as well as the “hardware virus” existed very popular in the electronic industry. Regardless of the time, such problem occurs if the required conditions are met. Thus, the electromagnetic discharge problem should not be overlooked.

From the above description, it is known that the electrostatic discharge problem for electronic products was not common before 1970. Many problems created by the electrostatic discharge were created because people did not have the consciousness about the electrostatic discharge. Even now, many people still have doubts about the damages to electronic products caused by electrostatic discharges. In fact, a vast majority of electrostatic discharge damages occurs beyond our senses, since the voltage of the electrostatic charges sensible to human bodies is about 3 KV and many electronic products will be damaged when the voltage is several hundreds volts or even several tens volts. In general, there is no specific range for an electronic device being damaged by electrostatic discharges. However, many problems occur after an electronic component is installed onto a circuit board and then tested. The troubleshooting is difficult, particularly for the measurement of the potential damages or significant changes of performance, even if they are measured by precision instruments. Therefore, many electronic engineers and designers have doubts about electrostatic charges. The experiments conducted in recent years show that the reliability of electronic products drops significantly within a certain period of time after such potential damage occurs.

The basic physical properties of electrostatic charges include attraction, repulsion and gravitational potential difference which will generate discharged electric currents. These three properties have the following influences to electronic components:
1. Electrostatic charges are adhered to dust and thus lowering the insulation and resistance of electronic components and shortening the life of electronic components.
2. Electrostatic charges damage electronic components, so that the electronic components are completely damaged and cannot work anymore.
3. The heat produced by the electrostatic discharge field or electric current potentially damage electronic components.
4. The electromagnetic field (up to several hundred volt/meter) produced by electrostatic discharges is very large, and the frequency (from several ten trillions to several thousand trillions) produced is very broad, which will cause an electromagnetic interference or even a damage to electronic products.

If an electronic product is damaged completely, it can be discovered and eliminated during the production and quality control process and thus having a smaller adverse effect. If an electronic product is damaged slightly and such damage cannot be discovered easily in regular tests, the damage is generally discovered after several manufacturing processes or even after the product has been used. Such slight damage to the electronic product is not only uneasy to detect, but also incurs a hard-to-estimate loss and consumes lots of manpower and cost to discover all problems. The loss will be huge if the problems are discovered after the product has been used.

In other words, the damages to electronic products caused by electrostatic discharges include the following:
1. Recessiveness: Human bodies cannot sense the electrostatic charges directly, unless the electrostatic charges are discharged. However, human bodies may not be able to sense the electrostatic discharge either, because the voltage of electrostatic discharge falls in the range of 2 to 3 KV. Therefore, the electrostatic charge is recessive.
2. Potentiality: The functions of certain electronic components after being damaged by electrostatic charges do not have any significant drop. However, these electronic components are damaged internally after being affected by electrostatic discharges for several times, and it creates a secret worry. Therefore, there is a potential damage to electronic components caused by electrostatic charges.
3. Randomness: After an electronic component is produced and before it is damaged, the whole process is threatened by the electrostatic charges. Only if the conditions for an electrostatic discharge are met anytime, the electrostatic discharge occurs. Therefore, the damage occurs randomly.
4. Complexity: The failure analysis of the electrostatic damage requires more time, more efforts, more costs, and a higher level of technology, since the electronic components are finer and smaller, and it usually needs to use high precision instruments. Even though precision instruments are adopted, it is difficult to distinguish some of the damages caused by electrostatic discharges from other damages. It is very often for people to mistaken the electrostatic damage and failure as other failures. Before fully knowing about the damages caused by electrostatic discharges, most people blame on the causes of previous failures and unknown failures, and thus unconsciously covering up the real cause of the damage. Therefore, the analysis of damages to electronic devices caused by electrostatic charges is complicated.

From the description above, it is obvious that the electrostatic discharge protection has significance on reducing the loss and improving the high quality and efficiency of the production of electronic components. Since the electronic technology is developed in a fast pace and new electronic products are introduced continuously, the general connectors of electronic devices or other components installed inside the electronic devices already have perfect electrostatic discharge protection, particularly there are many patents related to the electromagnetic inference resisting connectors.

As the products are developed with a multifunctional, fine and compact design, the space inside the products is reduced and the mechanical design becomes more complicated, which also makes the design for preventing the electrostatic discharge of the product more difficult. In addition, product purchasers have higher and higher requirements on the electrostatic discharge protection of the products. As a result, manufacturers have high difficulties on the product design. In recent years, the size of the keyboard of electronic devices becomes smaller and thinner, and thus continuous change on the design and material of the press keys of the keyboard is made. The general keyboard of an electronic device adopted by the industry mainly includes an external casing, a press key, a thin film circuit, and a circuit board; wherein the thin film circuit is divided into the following two types according to its structure and material:
(1) Poly Dome is a thin polyester film formed by thermal formation, which has a plurality of hemispherical and elastic protrusions on its surface, and an electric conductor (such as silver paste) on a recessive side of the thin polyester film, so that after the protruded side of the thin poly film is pressed, the electric conductor is disconnected from the corresponding electrode on the circuit board to produce a signal.
(2) Metal Dome is a metal hemisphere made of an electrically conductive metal by the stamping formation technology with a required height, radius, and shape, and then the metal hemisphere is adhered onto a thin film. The thin film is cut into a shape to fit the circuit board of a keyboard, so that the metal dome is kept in at a correct position and in a correct direction. An air hole is cut at the position surrounding where the metal dome is adhered, so that when the metal hemisphere is pressed, the metal dome can move freely. In general, the periphery of the metal dome is permanently in contact with an electrode under the circuit board at the bottom of the keyboard. When the metal dome is pressed, the center of the metal dome touches another electrode at the position corresponding to the center of the metal dome, and thus electrically connecting the two electrodes.

However, if an electronic product (such as a handset) adopts the metal dome and the electrostatic discharge test is performed, a high voltage current causing a permanent damage to the keyboard of the electronic device is found in the electrostatic discharge in the air. Such phenomenon and damage keeps the press key remained in the pressing status. After the keyboard is retested, the central processing unit 1 of the electronic product and a pin connected to the metal dome are penetrated and damaged by the high voltage. Further if the basic causes are examined, it is found that a bigger gap exists between the press key and the casing of the electronic product. The metal dome is disposed on the bottom of the press key, and air holes are disposed on the thin film of the metal dome, and an electrode 10 (as shown in FIG. 1) connected to the circuit board and the edge of the metal dome is connected directly to the central processing unit 1. Therefore, the high voltage is not blocked by any electronic component but will emit directly from the air hole to the metal dome and then from the electrode 10 to the central processing unit 1, and thus damaging the central processing unit 1.

Therefore, if the electronic product adopts the metal dome, it is necessary to solve the electrostatic discharge problem first; more particularly, it is a difficult problem for electronic product manufacturers to avoid the press key from being affected by the electrostatic discharge in a limited space of the electronic product without adding too many additional components or redesigning the structure or increasing the cost.

### SUMMARY OF THE INVENTION

The primary objective of the present invention is to install at least one press key on a casing, a circuit board inside the casing, a metal dome between the press keys and the circuit board inside the casing. The edge of the metal hemisphere of the metal dome is connected directly to an end of an electrode of the circuit board, and the other end of the electrode is connected to an end of a resistor. After the metal dome is pressed, the central position of the metal hemisphere is precisely above another electrode on the circuit board to define an electric connection and produce a press signal. Therefore, when the edge of the metal hemisphere receives a high voltage current, the keyboard is protected by the resistor to avoid the high voltage current from being sent directly to another end of the resistor which is connected to another electronic component to achieve the purpose of protecting another electronic component.

### BRIEF DESCRIPTION OF THE DRAWINGS

FIG. 1 is a circuit diagram of a traditional metal dome being connected onto a circuit board.

FIG. 2 is a circuit diagram of the metal dome being connected onto a circuit board according to the present invention.

FIG. 3 is a cross-sectional view of the metal dome being connected onto a circuit board according to the present invention.

FIG. 4 is another cross-sectional view of the metal dome being connected onto a circuit board according to the present invention.

### DETAILED DESCRIPTION OF THE PREFERRED EMBODIMENTS

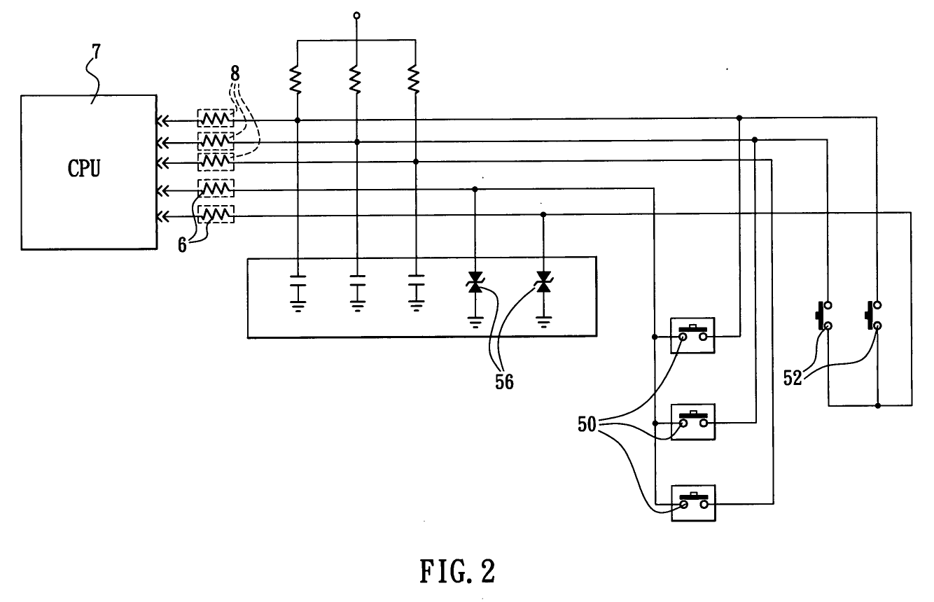

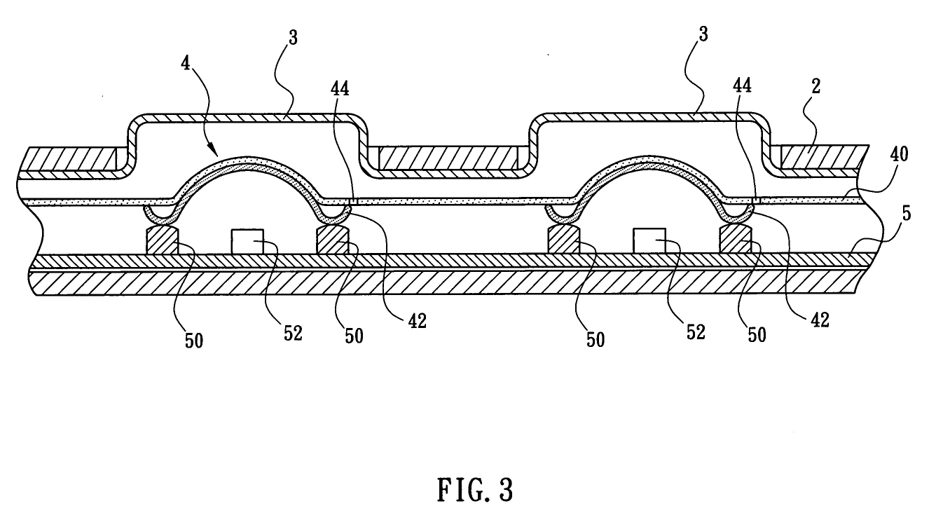

Please refer to the FIGS. 2 and 3 for the high voltage resisting keyboard according to the present invention, which comprises a casing 2; at least one press key 3 disposed on the casing 3, and one end of the press key 3 being extended into the casing 2; a metal dome 4 disposed at a corresponding position of the press key 3 in the casing 2; a thin film 40 and a plurality of metal hemispheres 42 are disposed on the metal dome 4; wherein the metal hemisphere 42 is adhered on the thin film 4 at a position corresponding to the press key 3, and a circuit board 5 is disposed in the casing 2 at a position corresponding to the metal dome, and all edges of the metal hemispheres 42 on the circuit board 5 connected directly to an electrode 50 are connected to one end of a resistor 6 and the other end of the resistor 6 is connected to another electronic component 7. After the metal dome 4 is pressed, the central position of the metal hemisphere 42 is electrically connected with another electrode 52 to produce a press signal. Therefore, the keyboard can be protected by the resistor 6 to avoid the high voltage from being sent to another electronic component 7 directly when the edges of the metal hemispheres 42 receives a high voltage (such as one from the electrostatic discharge).

The metal dome 4 is made of an electrically conductive material by using a stamping formation technology into a metal hemisphere 42 of specific height, diameter, and shape, and then the metal hemisphere 42 is adhered onto the thin film 40. The thin film 40 is cut into a required shape by using the laser cutting technology and then adhered onto the circuit board 5, so that the metal hemisphere 42 can be kept at a correct position and in a correct direction. Further, an air hole is cut from the position surrounding where the metal hemisphere 42 is adhered. If the metal hemisphere 42 is pressed, the metal hemisphere 42 can move freely. From the description above, the metal hemisphere 42 is actually very close to the outside, and it thus can further prevent a high voltage current from being sent from the metal hemisphere 42 to another electrode 52 of the metal hemisphere 42. In a preferred embodiment of the present invention, another electrode 52 is connected to an end of another resistor 8, and another end of said another resistor 8 is connected to another electronic component 7, so that said another resistor can further prevent the high voltage current from being sent to another electronic component 7 when the metal dome 4 receives a high voltage current.

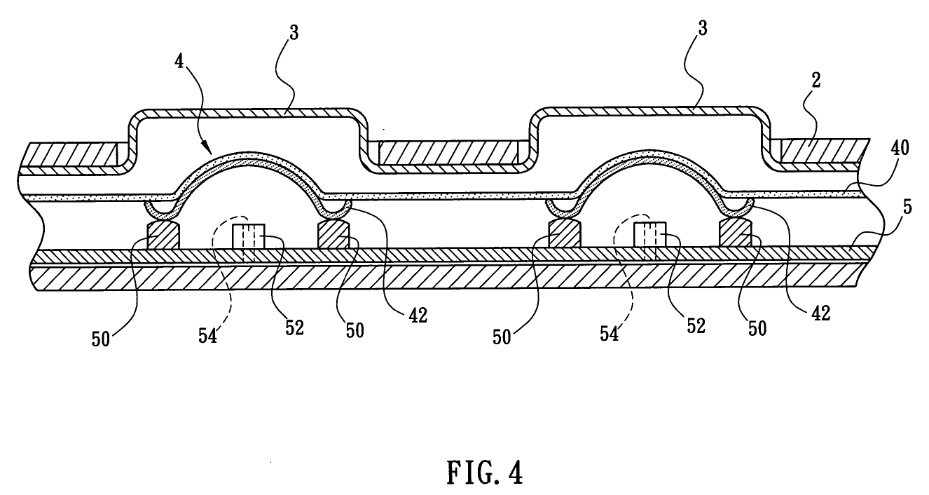

Please refer to FIGS. 3 and 4 for another preferred embodiment of the present invention. The thin film 40 does not require an air hole 44 being cut from the surrounding position of the metal hemisphere 42, but it just needs a penetrating hole 54 smaller than another electrode 52, so that when the metal dome 42 is pressed, the air between the metal dome 42 and the circuit board 5 can pass through the penetrating hole 54 freely to drive the metal hemisphere 42 to move accordingly. Such arrangement can avoid the electrostatic charges in the air from passing through the air hole 44 and being sent to the surrounding of the metal hemisphere 42 as to overcome the shortcomings of the traditional thin film. The present invention can further reduce the chance of sending electrostatic charges into the casing 2.

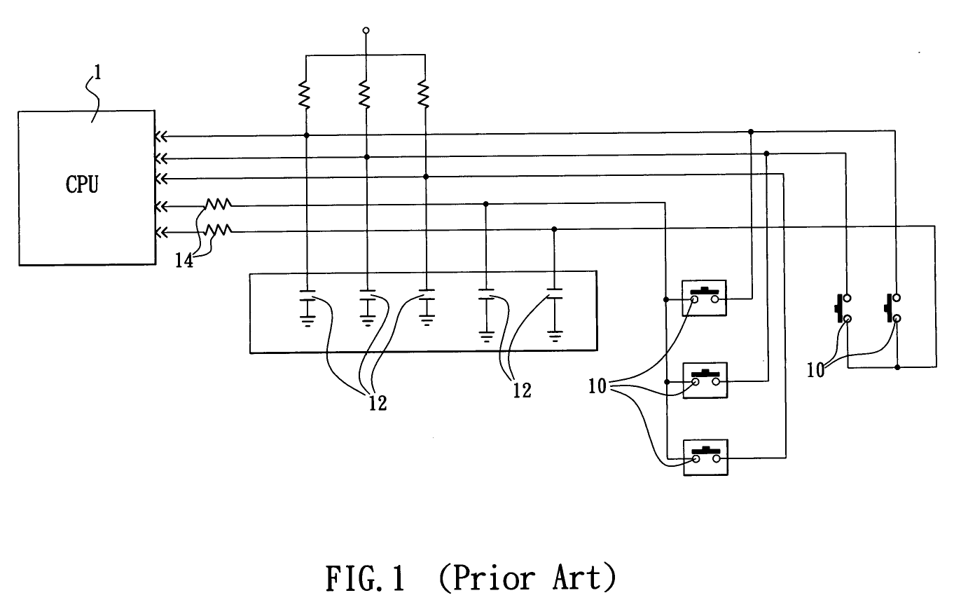

Please refer to FIG. 1. The traditional circuit board comes with a plurality of capacitors 12, and one end of these capacitors 12 is connected between the electrode 10 and the resistor 14, and another end is connected to a ground circuit, such that when an electric connection is formed between the metal dome 4 and the circuit board 5, and the capacitors 12 are charged first. After the capacitors 12 are charged, the press signal is produced, and then the electric capacity of the capacitor 12 flows out from the ground circuit. Such arrangement can avoid the generation of unnecessary press signals if the metal dome 4 is in contact with the circuit board 5 for a split second caused by the shaking or vibration of the keyboard. Please refer to FIGS. 1 to 3 for another preferred embodiment of the present invention. The capacitor 12 of the traditional circuit board can be substituted by a variable resistor 56, so that if a high voltage current accidentally passes into the casing, the high voltage current will cause a short circuit to the variable resistor 56, and the high voltage current will pass through the variable resistor 56 into the ground circuit, and thus will not pass into another electronic component 7 to avoid damaging another electronic component 7 and achieve the purpose of protecting another electronic component. In this embodiment, the casing 2 could be a casing of a wireless communication product.

From the foregoing components, it is known that the electrode 50 directly connected between the metal dome 4 and the circuit board 5 is connected to an end of the resistor 6, and another end of the resistor is connected to another electronic component 7 (such as a central processing unit) to achieve the purpose of protecting another electronic component 7. Further, another electrode 52 is connected to one end of another resistor 8 and another end of said another resistor 8 is connected to another electronic component 7, or a penetrating hole 54 smaller than another electrode 52 is set on the circuit board 5 at a position corresponding to the metal dome 42, or the capacitor 12 is substituted by the variable resistor 56 to minimize the chance of damaging the keyboard with a high voltage current.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A high voltage resisting keyboard, comprising:
a casing;
at least one press key, disposed on said casing and one end of said press key being extended into said casing;
a metal dome, disposed in said casing at a position corresponding to said press key, and comprising a thin film and a plurality of metal hemispheres, wherein said metal hemisphere being adhered onto said thin film at a position corresponding to said press key; and
a circuit board, disposed in said casing at a position corresponding to said metal dome, and an electrode disposed on said circuit board and directly coupled to said metal hemisphere being coupled to an end of a resistor, and another end of said resistor being connected to another electronic component, thereby after said metal dome is pressed, the central position of said metal hemisphere constitutes an electric connection with another electrode on said circuit board.

2. The high voltage resisting keyboard of claim 1, wherein said another electrode is coupled to one end of another resistor, and the other end is coupled to another electronic component.

3. The high voltage resisting keyboard of claim 1, wherein said circuit board comprises a penetrating hole being smaller than said another electrode and disposed said circuit board at a position corresponding to said metal hemisphere, instead of having an air hole cut from said thin film at a position surrounding said metal hemisphere.

4. The high voltage resisting keyboard of claim 1, wherein said circuit board comprises a plurality of capacitors, and one end of said capacitor is coupled between said electrode and said resistor, and the other end is coupled to a ground circuit, so that when said metal dome is electrically coupled to said circuit board, said capacitor is charged first and then produces a press signal after the capacitor is charged, and the electric capacity of said capacitor flows out from said ground circuit.

5. The high voltage resisting keyboard of claim 4, wherein said capacitor is substituted by a variable resistor.
